(19) United States
(12) Patent Application Publication
(10) Pub. No.: US 2025/0251805 A1
(43) Pub. Date: Aug. 7, 2025

(54) "SV BASE" SILICONE GAMING MOUSEPAD

(71) Applicant: Dawson Gray, Waterville, ME (US)

(72) Inventor: Dawson Gray, Waterville, ME (US)

(21) Appl. No.: 18/623,362

(22) Filed: Apr. 1, 2024

Related U.S. Application Data
(60) Provisional application No. 63/549,764, filed on Feb. 5, 2024.

(51) Int. Cl. G06F 3/039; B32B 5/02; B32B 5/06; B32B 27/12; B32B 27/28; B32B 37/12; B32B 37/18; B32B 38/00

(52) U.S. Cl. CPC G06F 3/0395; B32B 5/02; B32B 5/073; B32B 27/12; B32B 27/283; B32B 37/12; B32B 37/182; B32B 38/00; B32B 2038/008; B32B 2250/02; B32B 2255/02; B32B 2255/26; B32B 2264/1021; B32B 2305/18; B32B 2307/536; B32B 2307/744; B32B 2383/00; B32B 2457/00

(57) ABSTRACT

According to an aspect of the present invention, there is provided a mousepad for gaming or work purposes with a silicone base. The present invention provides a consistent base that has anti-slip properties to ensure no movement happens when the mousepad is being used. The silicone base uses combinations of materials to achieve the consistency desired. The silicone base has no middle layer between the silicone and fabric surface, allowing a more consistent, accurate area due to the fabric being applied directly to the silicone base. The present invention has a unique stitched edge that is stitched directly into the silicone base without a middle layer of foam or other material. Logos, text, designs or artwork can be embedded into the silicone.

### BACKGROUND

Mousepads have been described a number of times in the prior art patent literature.

For example, U.S. Pat. No. 5,952,070 discloses a mouse pad comprising a sheet of plastics material having a thickness less than 0.01 inch with a layer of adhesive coated on a lower side of the sheet, the layer being covered by a peelable covering sheet, the pad having an upper surface which is arranged with surface characteristics, width and length to allow the movement of a mouse thereon which is sufficient to cause rotation of a ball of the mouse to provide input to a computer, the adhesive layer being substantially directly coated on the plastics material such that the mouse pad when applied to a horizontal surface of a desk consists of substantially solely of the adhesive layer and the sheet.

US20050224679 discloses that mousepad coating may be polytetrafluoroethylene and preferably sintered-on polytetrafluoroethylene. Another embodiment comprises a mouse pad for use as a substrate for computer mice to move across which comprises a one-piece backing having flexural rigidity which consists of polytetrafluoroethylene and has a roughed surface.

While mouse pads are known, prior art mouse pads suffer from limitations including lack of consistent performance.

### SUMMARY OF INVENTION

The present invention discloses silicone mouse pads that have no middle layer between the silicone base and the fabric.

According to an aspect of the present invention, there is provided gaming mousepad, comprising: a silicone base; and a fabric surface, wherein the fabric surface is directly attached to the silicone base without a middle layer.

According to another aspect of the present invention, there is provided method of manufacturing a mousepad, comprising: creating one or more custom molds with logos, text, design or artworks; pouring raw materials into the one or more custom molds in the production process to embed the logos, text, design or artworks into the silicone base; applying heavy duty commercial glue to the silicone base; placing the fabric surface on top of the silicone base; and sewing stitched edges into the silicone base.

### BRIEF DESCRIPTION OF THE DRAWING

FIG. 1 illustrates a mousepad according to the present invention.

FIG. 2 illustrates a top view of the mousepad according to the present invention.

FIG. 3 illustrates a side view of the mousepad according to the present invention.

FIG. 4 illustrates mouse at the center of the mousepad according to the present invention.

FIG. 5 illustrates a cross-sectional view of the mousepad according to the present invention.

FIG. 6 illustrates a mouse on an edge of the mousepad according to the present invention.

FIG. 7 illustrates a mousepad according to the present invention next to a keyboard.

### DETAILED DESCRIPTION

The gaming mousepad is used for providing a surface for the computer mouse to be used on. This surface in gaming is designed to provide the computer mouse the most accurate sensor data.

Prior art gaming mousepads use a simple 3 layer system which consists of the following: a rubber anti-slip base or an alternative material such as PORON®, Foam middle layer and a cloth fabric top layer which is used to provide an accurate surface for the computer mouse.

Consistency is poor in gaming mousepads due to the soft foam middle layer. The softness creates inconsistencies that the computer mouse reports sensor data on to the CPU of a computer.

This not only creates small errors in sensor reporting but furthermore the soft foam middle layer creates issues for the user directly in terms of applying pressure to the mouse pad. Slight differences in the amount of pressure will let the computer mouse sink into the foam middle layer which provides incorrect sensor data to the computer mouse and also will not let the user create muscle memory which is important in First Person Shooter games such as Call Of Duty, Battlefield, Counter Strike Global Offensive and Valorant.

The present invention utilizes silicone with a hardness of 30A, 40A, 50A and 60A or any silicone that uses the advancement of a polished silicone or other additive to enhance anti-slip properties of the gaming mousepad while providing a firm, consistent surface.

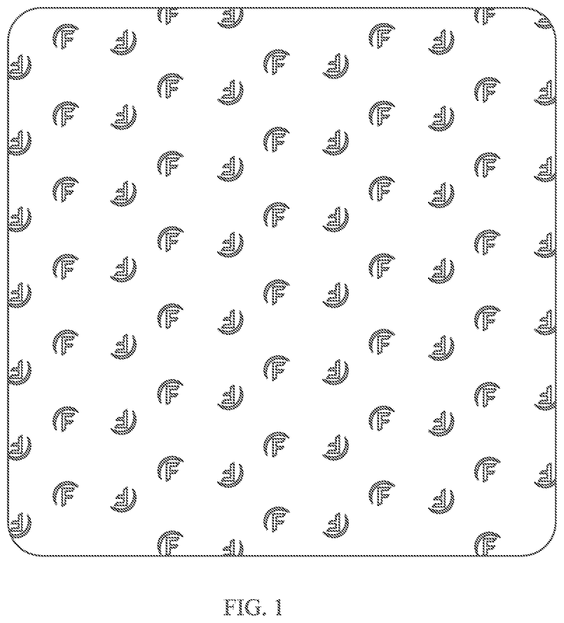

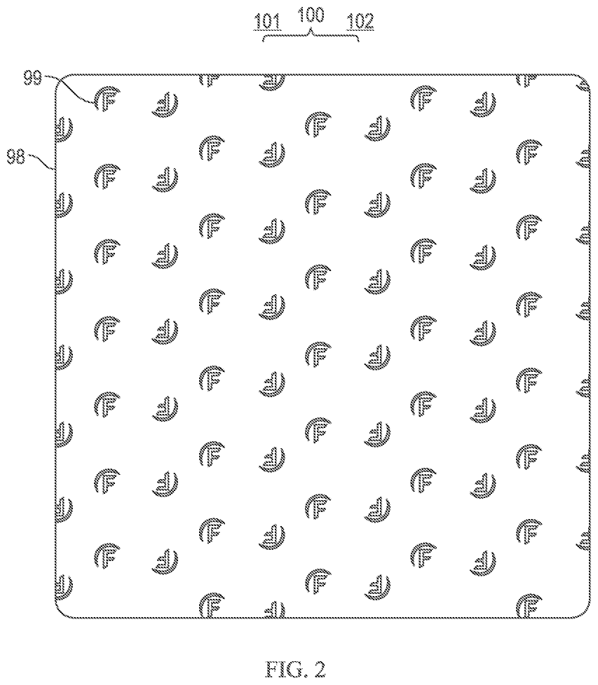

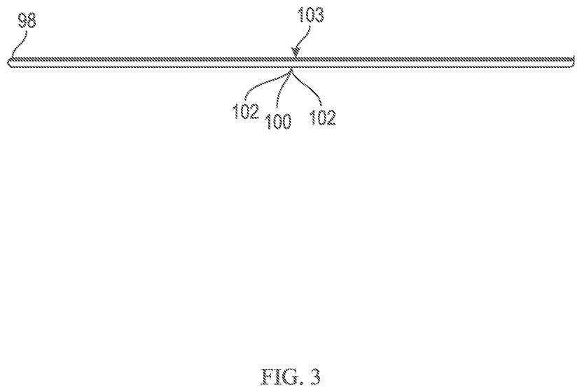

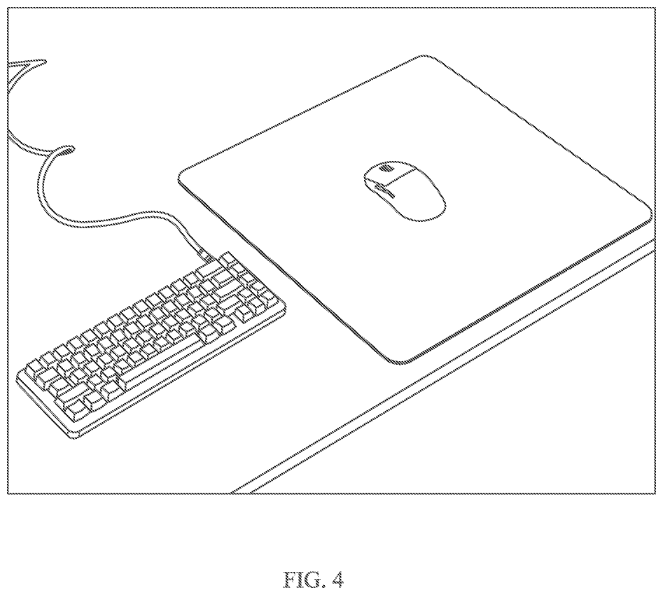

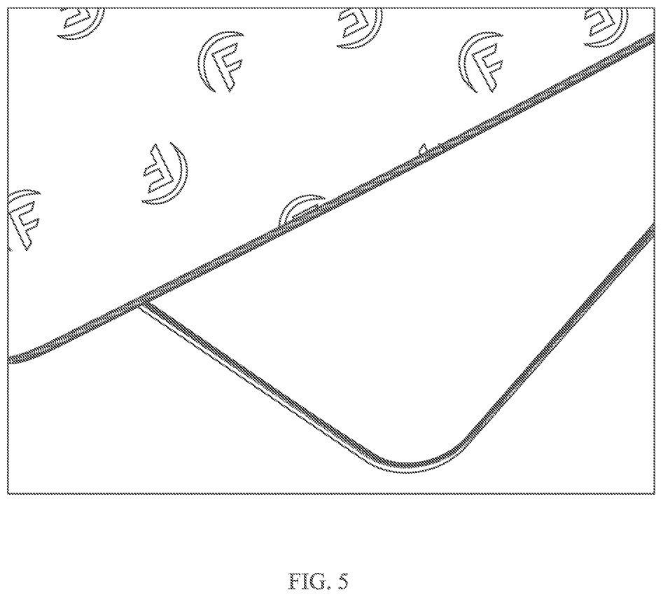

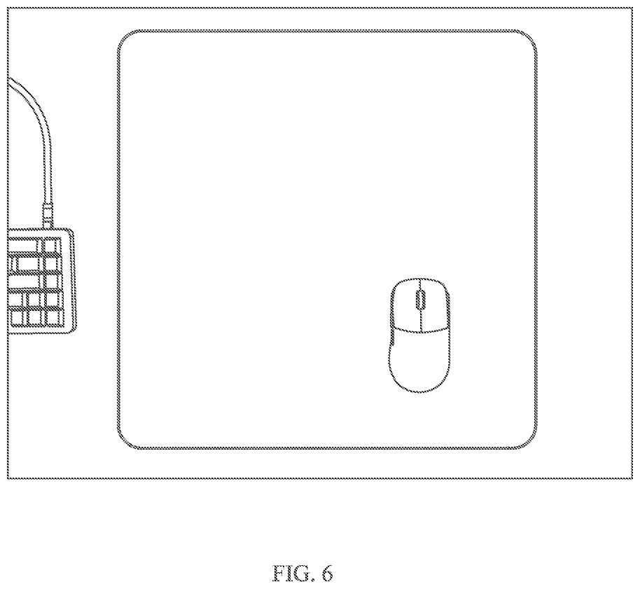

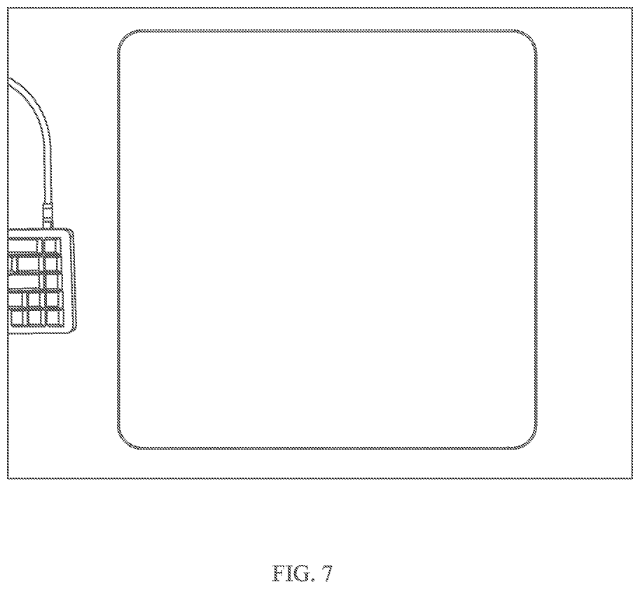

In FIGS. 1-7, Stitched edges that are directly stitched into the silicone base. Design such as a logo, artwork or text embedded directly into the silicone base. Silicone, Polished Silica and Vynex or other stiffness additives is the material composition of the silicone base. Fabric on top of the silicone base without any middle layer between the silicone base and the fabric.

The invention uses a firm silicone base [100], [101], with no middle layer between the silicone base [100], [101], and fabric surface layer [103]. Utilizing custom molds to embed company logos, text, design or

artworks directly into the silicone base by pouring the raw materials into the mold in the production process.

The silicone base uses several materials [100], [101], to enhance the anti-slip properties of the gaming mousepad and to ensure the desired firmness of the silicone base is achieved.

Polished Silica is applied during the production of the silicone base, the polish applies a shiny appearance to the silicone base and enhances the anti-slip properties. Vynex or other materials are used to reach the desired firmness for the silicone base.

The material composition of the silicone base is unique, innovative and is a key part in the invention. Once the silicone base [100], [101], has been produced heavy duty commercial glue is applied to the silicone base and the fabric surface is placed on top of the silicone base.

With no middle layer between the silicone base [100], [101], and the fabric surface it provides a consistent surface for the computer mouse that performs more accurately compared to other gaming mousepads due to the unique firmness and surface of the invention. Stitched edges are sewed into the silicone base [100], [101], to ensure longevity and usability of the gaming mousepad.

The stitched edges permit a comfortable user experience while also showing the craftsmanship required with this invention.

Stitching directly into such a firm and rigid material is unheard of with gaming mousepads. This is because of the difficulty, manual labor, broken needles, time and quality required to do so.

The invention is the first of its kind to bring the unique firmness of the “SV BASE” silicone base and the consistency of the fabric surface layer with stitched edges to the market.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A gaming mousepad, comprising:
a silicone base; and
a fabric surface,
wherein the fabric surface is directly attached to the silicone base without a middle layer.

2. The gaming mousepad of claim 1, wherein the silicone base comprises polished silica.

3. The gaming mousepad of claim 1, wherein the silicone base has 25A, 30A, 35A, 40A, 50A, or 60A firmness.

4. The gaming mousepad of claim 1, further comprising vynex coating.

5. The gaming mousepad of claim 1, wherein the mousepad has stitched edges that are directly stitched from the fabric surface into the silicone base.

6. The gaming mousepad of claim 1, further comprising additives to calibrate the firmness or softness of the silicone.

7. The gaming mousepad of claim 1, further comprising logos, text, or designs.

8. The gaming mousepad of claim 1, further comprising one or more additives to enhance anti-slip properties.

9. The gaming mousepad of claim 1, wherein the mousepad is square or rectangular.

10. The gaming mousepad of claim 7, wherein the logos, text or designs are embedded directly into the silicone base.

11. A method of manufacturing a mousepad, comprising:
creating one or more custom molds with logos, text, design or artworks;
pouring raw materials into the one or more custom molds in the production process to embed the logos, text, design or artworks into the silicone base;
applying heavy duty commercial glue to the silicone base;
placing the fabric surface on top of the silicone base; and
sewing stitched edges into the silicone base.
